(19) United States
(12) Patent Application Publication
(10) Pub. No.: US 2026/0005387 A1
(43) Pub. Date: Jan. 1, 2026

(54) BATTERY CELLS WITH GAS GUIDING PLATE, FRAME, OR SPRINGS ARRANGED BETWEEN BATTERY STACKS OR ROLLS

(71) Applicant: GM GLOBAL TECHNOLOGY OPERATIONS LLC, Detroit, MI (US)

(72) Inventors: Liang XI, Northville, MI (US); SriLakshmi KATAR, Troy, MI (US); Srikant SRINIVASAN, Novi, MI (US); Ryan Patrick HICKEY, Austin, TX (US)

(21) Appl. No.: 18/754,578

(22) Filed: Jun. 26, 2024

(51) Int. Cl. H01M 50/367; H01M 50/15; H01M 50/103

(52) U.S. Cl. CPC H01M 50/367; H01M 50/15; H01M 50/103; H01M 2200/20

(57) ABSTRACT

A battery cell includes a battery enclosure including a lid with a vent. N battery portions arranged in the battery enclosure and including a plurality of cathode electrodes, anode electrodes and separators. The N battery portions comprise one of a battery stack and a battery roll. N is an integer greater than one. G gas guiding plates are arranged between at least two of the N battery portions and include a plurality of gas channels configured to guide gases produced by the at least two of the N battery portions towards the vent. G is an integer greater than zero.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a battery cell with a gas guiding plate, frame, or springs arranged between battery stacks or rolls.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes a battery enclosure including a lid with a vent. N battery portions are arranged in the battery enclosure and include a plurality of cathode electrodes, anode electrodes and separators. The N battery portions comprise one of a battery stack and a battery roll. N is an integer greater than one. G gas guiding plates are arranged between at least two of the N battery portions and include a plurality of gas channels configured to guide gases produced by the at least two of the N battery portions towards the vent. G is an integer greater than zero.

In other features, the battery enclosure is a prismatic enclosure including wide faces and narrow faces, and the N battery portions extend in a longitudinal direction of the wide faces.

In other features, the battery enclosure is a prismatic enclosure including wide faces and narrow faces, and the N battery portions extend in a direction transverse to a longitudinal direction of the wide faces.

In other features, the plurality of gas channels extend from one side of the N-1 gas guiding plates to the other side, lower ends of the plurality of gas channels are one of open and closed, and upper ends of the plurality of gas channels are open.

In other features, the plurality of gas channels of the N-1 gas guiding plates include first gas channels on one side of the N-1 gas guiding plates and second gas channels on an opposite side of the N-1 gas guiding plates, lower ends of the first gas channels and the second gas channels are one of open and closed, and upper ends of the first gas channels and the second gas channels are open.

In other features, the first gas channels and the second gas channels extend vertically, and the first gas channels are laterally offset from the second gas channels.

In other features, first and second covers extending over the first gas channels and the second gas channels, respectively. The first and second covers include a plurality of gas holes in fluid communication with the first gas channels and the second gas channels, respectively.

In other features, the first and second covers are separate from the N-1 gas guiding plates. The first and second covers are formed integrally with the N-1 gas guiding plates. The N-1 gas guiding plates are made of a material selected from a group consisting of polymer, composite, metal, and combinations thereof.

A battery cell includes a battery enclosure including a lid with a vent. N battery portions arranged in the battery enclosure and including a plurality of cathode electrodes, anode electrodes and separators, wherein the N battery portions comprise one of a battery stack and a battery roll and N is an integer greater than one. G gas guiding frames are arranged between at least two of the N battery portions and include at least one of a top frame member and a bottom frame member or first and second side frame members. G is an integer greater than one and the G gas guiding frames define a cavity with sides of corresponding ones of the N battery portions. At least one of the at least one of the top frame member and the bottom frame member and the first and second side frame members includes one or more holes adjacent to the vent.

In other features, the battery enclosure is a prismatic enclosure including wide faces and narrow faces, and wherein the N battery portions extend in a longitudinal direction of the wide faces.

In other features, the battery enclosure is a prismatic enclosure including wide faces and narrow faces. The N battery portions extend in a direction transverse to a longitudinal direction of the wide faces. A plurality of supports extend between the top frame member and the bottom frame member. A plurality of supports extend between the side frame members.

In other features, the N-1 gas guiding frames are made of a material selected from a group consisting of polymer, composite, metal, and combinations thereof.

A battery cell includes a battery enclosure including a lid with a vent. N battery portions are arranged in the battery enclosure and including a plurality of cathode electrodes, anode electrodes and separators, wherein the N battery portions comprise one of a battery stack and a battery roll and N is an integer greater than one. One or more springs are arranged between the N battery portions.

In other features, the battery enclosure is a prismatic enclosure including wide faces and narrow faces, and the N battery portions extend in a direction transverse to a longitudinal direction of the wide faces. The one or more springs are made of a material selected from a group consisting of polymer, a composite, metal, and combinations thereof.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell stack including C cathode electrodes, A anode electrodes, and S separators;

FIG. 2 is a perspective view of a prismatic battery cell;

FIG. 3 side cross section of an example of a battery cell including first and second battery stacks or rolls arranged in a battery enclosure;

FIGS. 4A and 4B are side cross sections of an example of a battery cell including first and second battery stacks or rolls arranged in a battery enclosure with a gas guiding plate arranged therebetween according to the present disclosure;

FIG. 5 is a plan view another example of a battery cell including first and second battery stacks or rolls arranged in a battery enclosure with a gas guiding plate arranged therebetween according to the present disclosure;

FIG. 6 is a side view of the gas guiding plate of FIG. 5 according to the present disclosure;

FIGS. 7A and 7B are plan views of examples of battery cells including first and second battery stacks or rolls arranged in a battery enclosure with a gas guiding plate arranged therebetween according to the present disclosure;

FIG. 8 is a side view of the gas guiding plate of FIG. 7B according to the present disclosure;

FIG. 9 is a plan view of another example of a battery cell including first and second battery stacks or rolls arranged in a battery enclosure with a gas guiding plate arranged therebetween according to the present disclosure;

FIGS. 10A and 10B are plan views of examples of battery cells including first and second battery stacks or rolls arranged in a battery enclosure with a gas guiding plate arranged therebetween according to the present disclosure;

FIG. 11 is a side view of another example of a gas guiding plate according to the present disclosure;

FIG. 12 is a side view of another example of a gas guiding plate according to the present disclosure; and

FIG. 13 is a plan view of another example of a battery cell including first and second battery stacks or rolls arranged in a battery enclosure with one or more springs arranged therebetween according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

High energy battery packs are utilized in many consumer and industrial sectors including transportation and power grid applications. High capacity battery packs are known to include a plurality of battery pack modules allowing for flexibility in configurations and adaptation to application requirements.

These battery packs generate heat and internal pressure when placed under load. Heat may have a detrimental effect on battery efficiency and/or battery life, and a buildup of internal pressure during a thermal event in the battery may result in failure of the battery pack. Accordingly, removing the heat and lowering the internal pressure improves battery operation.

Large format battery cells with higher power densities can be used to reduce battery pack costs by lowering both cell and non-cell costs. The cost of battery cell mechanical components, such as cap plates, decreases on a per kWh basis with higher battery cell energy. Additionally, higher battery cell energy allows for fewer cells in a battery pack, which reduces the number of components, overall pack cost, and/or mass. The higher power levels increase the risk of battery cell rupture during a thermal runaway event due to the increased energy of the larger battery cells and/or increased volume of gas released by the larger battery cells. In some examples, the larger battery cells may include two or more battery stacks or rolls (e.g., “jelly rolls”) that are connected the positive and negative terminals of the battery cell.

To mitigate the risk of higher energy density, battery cells according to the present disclosure include a gas guiding plate with gas channels arranged between battery stacks or rolls. In some examples, the gas channels guide the gas produced during a thermal runaway event towards the vent of the battery cell and away from the other battery stacks or rolls in the battery cell enclosure. Improved physical control of the gases delays the heating of the other battery stacks or rolls within the same battery enclosure. As a result, the battery cells have a reduced risk of cell rupture.

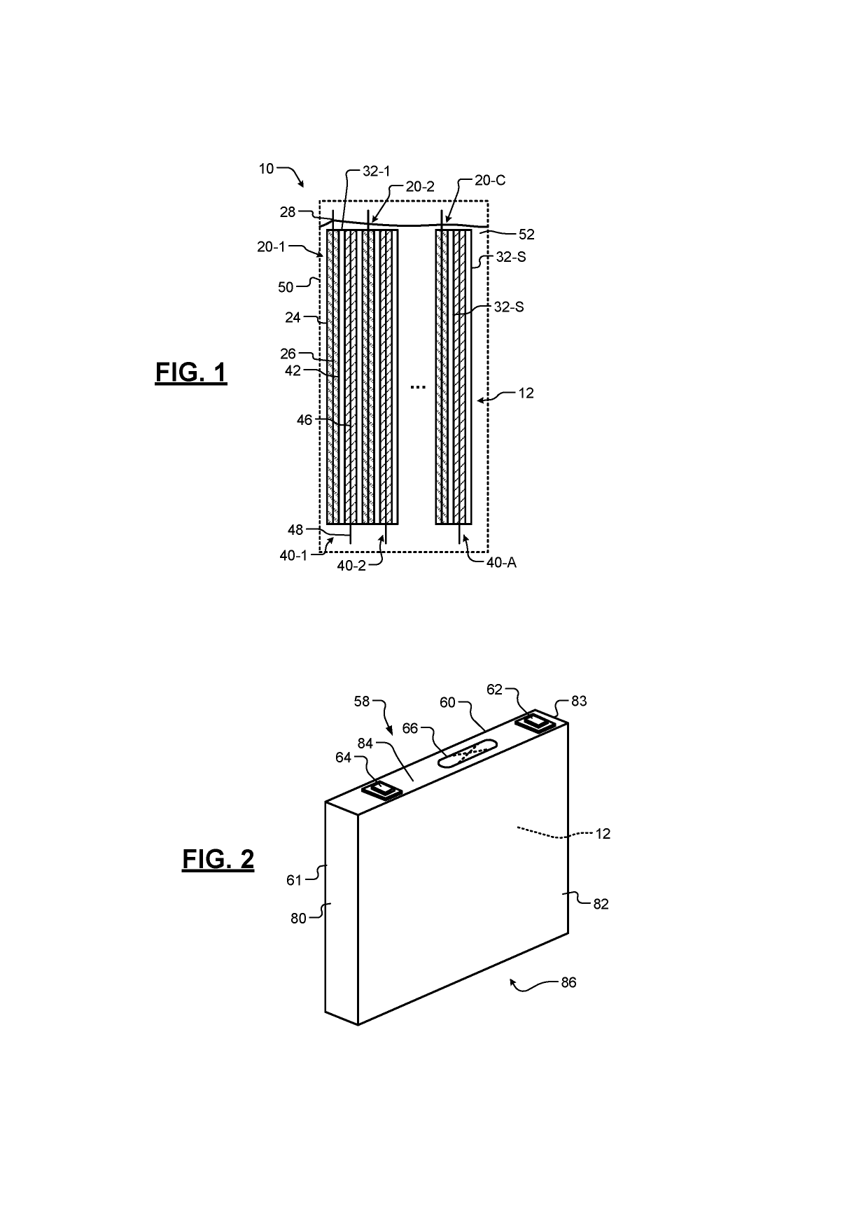

Referring now to FIG. 1, a battery cell 10 includes C cathode electrodes 20, A anode electrodes 40, and S separators 32 arranged in a predetermined sequence in a battery cell stack or roll 12, where C, S and A are integers greater than zero. The battery cell stack or roll 12 is arranged in an enclosure 50. Liquid electrolyte 52 is added to the enclosure 50. While a single battery stack or roll is shown, multiple battery stacks or rolls can be arranged in the same battery enclosure as will be described further below.

The C cathode electrodes 20-1, 20-2, ..., and 20-C include a cathode active material layer 24 arranged on one or both sides of a cathode current collector 26. The A anode electrodes 40-1, 40-2, ..., and 40-A include anode active material layers 42 arranged on one or both sides of the anode current collectors 46. The S separators 32-1, 32-2, …, and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more optional conductive additives, and/or one or more optional binder materials that are cast or applied onto one or both sides of the current collectors 26 and/or 46, respectively.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack or roll 12. The external tabs 28 and 48 of each battery stack or roll are connected to terminals of the battery cells.

Referring now to FIG. 2, a battery cell 58 includes an enclosure 60. In some examples, the enclosure 60 has a prismatic shape with rectangular cross-sections in x-, y- and z-axis planes. In some examples, the enclosure 60 includes an enclosure body 61 including sides 80 corresponding to narrow faces and sides 82 corresponding to wide faces. The enclosure body 61 defines an open-ended rectangular prism. In some examples, the enclosure 60 includes a lid portion 84 and a bottom portion 86. In other examples, the bottom portion 86 is attached after the enclosure 60 is formed.

The lid portion 84 and optionally the bottom portion 86 are attached to the enclosure body 61 to enclose top and the bottom openings of the enclosure body 61, respectively. The battery cell 58 includes external terminals 62 and 64 that pass through the lid portion 84. One or more battery cell stacks or rolls 12 are arranged in the enclosure 60.

The external terminals 62 and 64 are connected to external tabs 28 and 48 of one or more battery cell stacks or rolls 12. The lid portion 84 (and/or the bottom portion 86 and/or side faces) includes a pressure-based vent cap 66. The pressure-based vent cap 66 is configured to release vent gases when pressure within the enclosure is greater than a predetermined pressure. In some examples described further below, the gas channels of the gas guiding plate are configured to direct gases produced by one of the battery stacks or rolls toward the vent of the enclosure and away from other battery stacks or rolls.

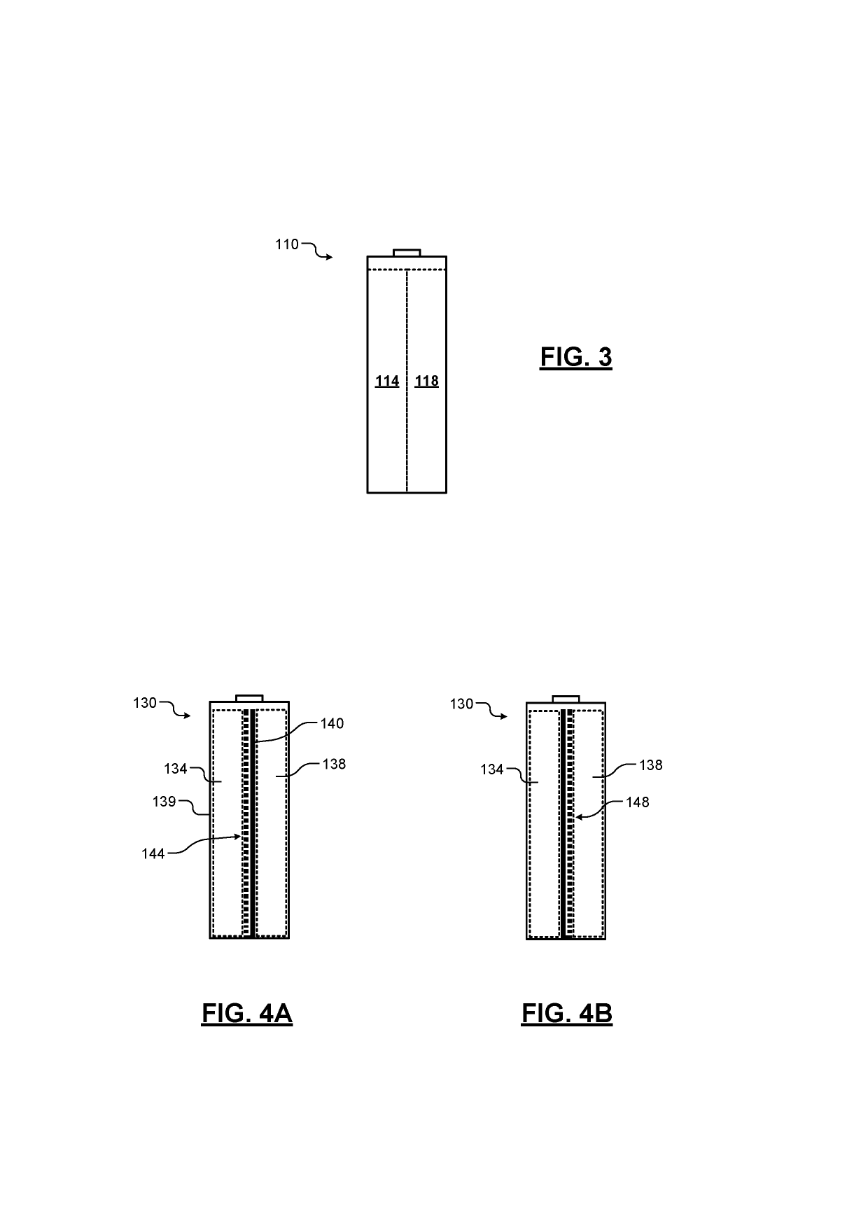

Referring now to FIGS. 3 to 6, some battery cells include two or more battery stacks or rolls (e.g., “jelly rolls”) including cathode electrodes, anode electrodes, and separators stacked in a predetermined order. The cathode electrodes and anode electrodes of the battery stacks or rolls are connected to the positive terminal and negative terminal of the battery cell.

In FIG. 3, a battery cell 110 includes first and second battery stacks or rolls 114 and 118 arranged in a battery enclosure (e.g., a prismatic enclosure). It may be difficult for gases produced by one of the battery stacks or rolls during a thermal runaway event to reach the vent of the enclosure since the battery stacks or rolls are tightly packed. This may lead to heating of the other battery stack or roll and may cause the other battery stack or roll in the enclosure to experience thermal runaway.

In FIGS. 4A and 4B, a battery cell 130 includes first and second battery stacks or rolls 134 and 138 arranged in a battery enclosure 139. As can be appreciated, the battery cells described herein can have N battery stacks and/or rolls with N-1 gas guiding plates arranged between them (where N is an integer greater than 1). In this example, the first and second battery stacks or rolls 134 and 138 extend in a longitudinal direction of the wide faces.

A gas guiding plate 140 including gas channels 144 and 148 extending vertically on opposite sides thereof is arranged between the first and second battery stacks or rolls 134 and 138. The gas channels 144 and 148 can be open on both ends or closed at a bottom end and open at the top end. In some examples, the shape of the gas channels 144 and 148 is circular, oval, square, trapezoidal, rectangular, triangular, hexagonal, or other suitable cross sectional shapes. In some examples, the gas guiding plate 140 is made of a non-conductive material. In some examples, the gas guiding plate 140 is made of a material selected from a group consisting of polymer, composite, and/or metal (e.g., metal coated with a non-conductive coating).

Gases enter the gas channels 144 and 148, respectively, from the battery stack or roll experiencing thermal runaway. The gas guiding plate 140 guides gases to the vent with less heating of the other battery stacks or rolls.

In some examples, a thickness of the gas guiding plate 140 is in a range from 0.25mm to 3 mm. In some examples, a thickness of the gas guiding plate 140 is in a range from 0.4mm to 1 mm (e.g., 0.7mm). In some examples, the gas channels have a depth in a range from 20% to 95% of the thickness of the gas guiding plate 140. In some examples, the channels have a depth in a range from 65% to 85% of the thickness of the gas guiding plate 140.

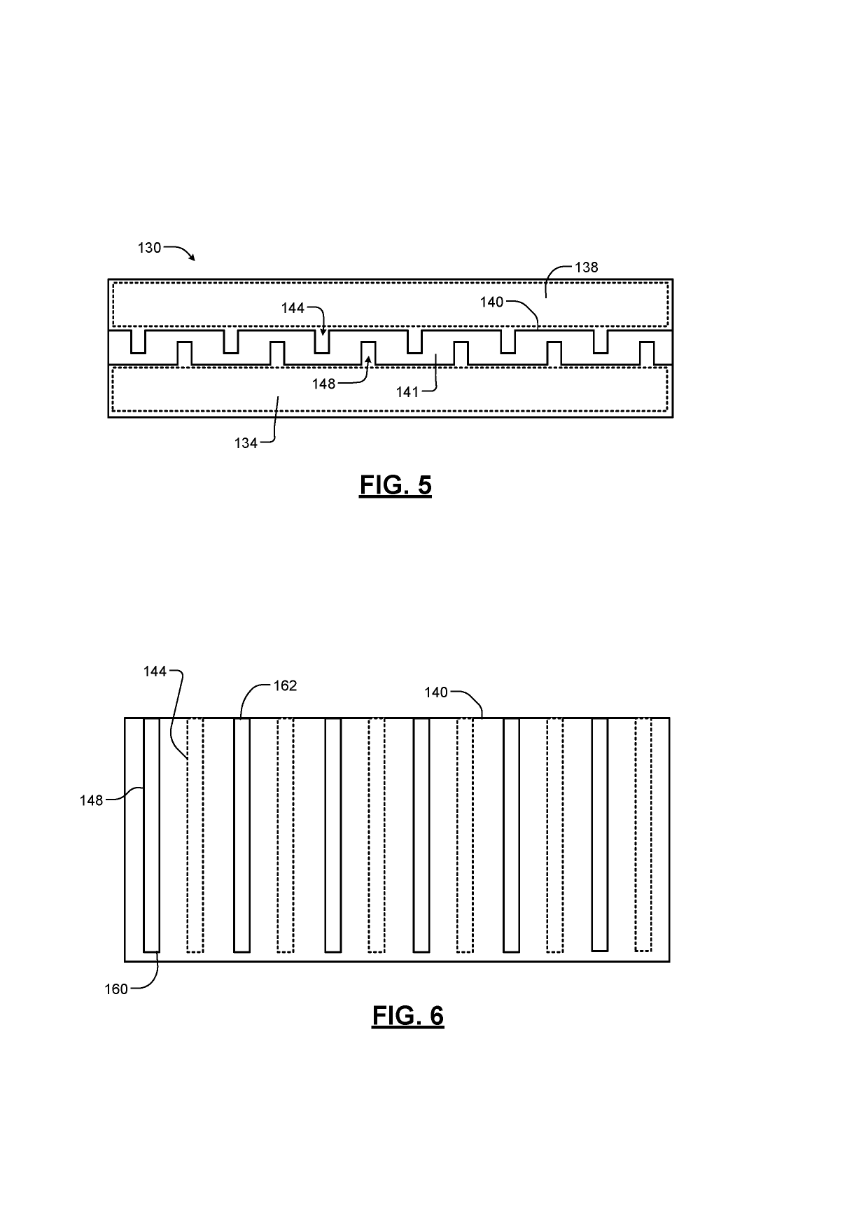

In FIG. 5, the gas guiding plate 140 includes a body 141 having a rectangular cross section. The gas channels 144 and 148 are arranged on opposite sides of the body 141 of the gas guiding plate 140. In some examples, the gas channels 144 and 148 extend vertically and are offset from one another in a longitudinal direction on opposite sides of the gas guiding plate 140.

In FIG. 6, the gas channels 144 and 148 are closed at one end 160 adjacent to a bottom edge of the gas guiding plate to prevent gases from flowing downwardly away from the vent. The gas channels 144 and 148 are open at another end 164 adjacent to a top edge of the gas guiding plate near the vent to direct the heated gases in that direction.

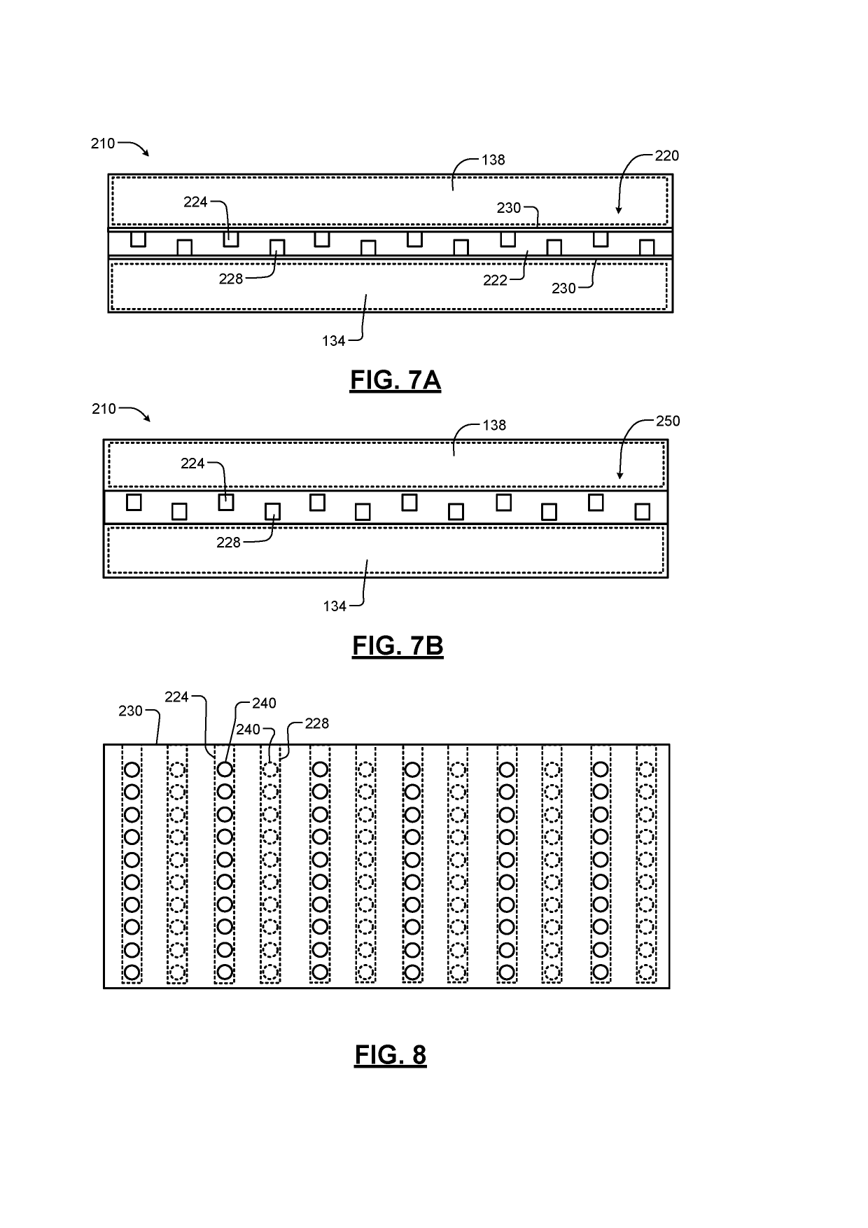

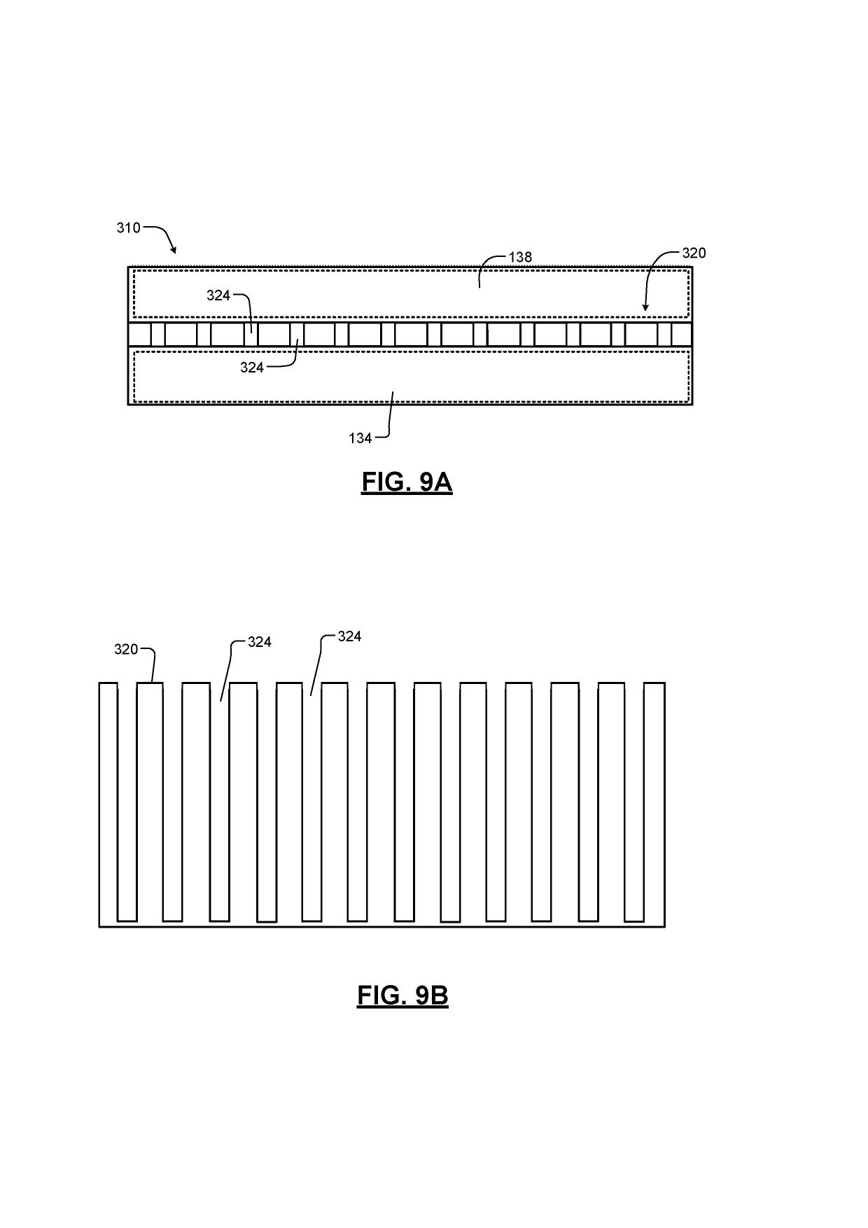

Referring now to FIGS. 7A to 8, other examples of the gas guiding plates are shown. In FIG. 7A, a battery cell 210 includes a gas guiding plate 220 including an inner portion 222 similar to FIG. 5 and covers 230 arranged on opposite sides thereof. The covers 230 include a plurality of gas holes 240 (e.g., shown in FIG. 8) that are spaced by a predetermined distance and aligned with gas channels 224 and 228. The covers 230 and the gas guiding plates 220 can be separate pieces (FIG. 7A) or integrated into a single piece (e.g., using injection molding) (FIG. 7B).

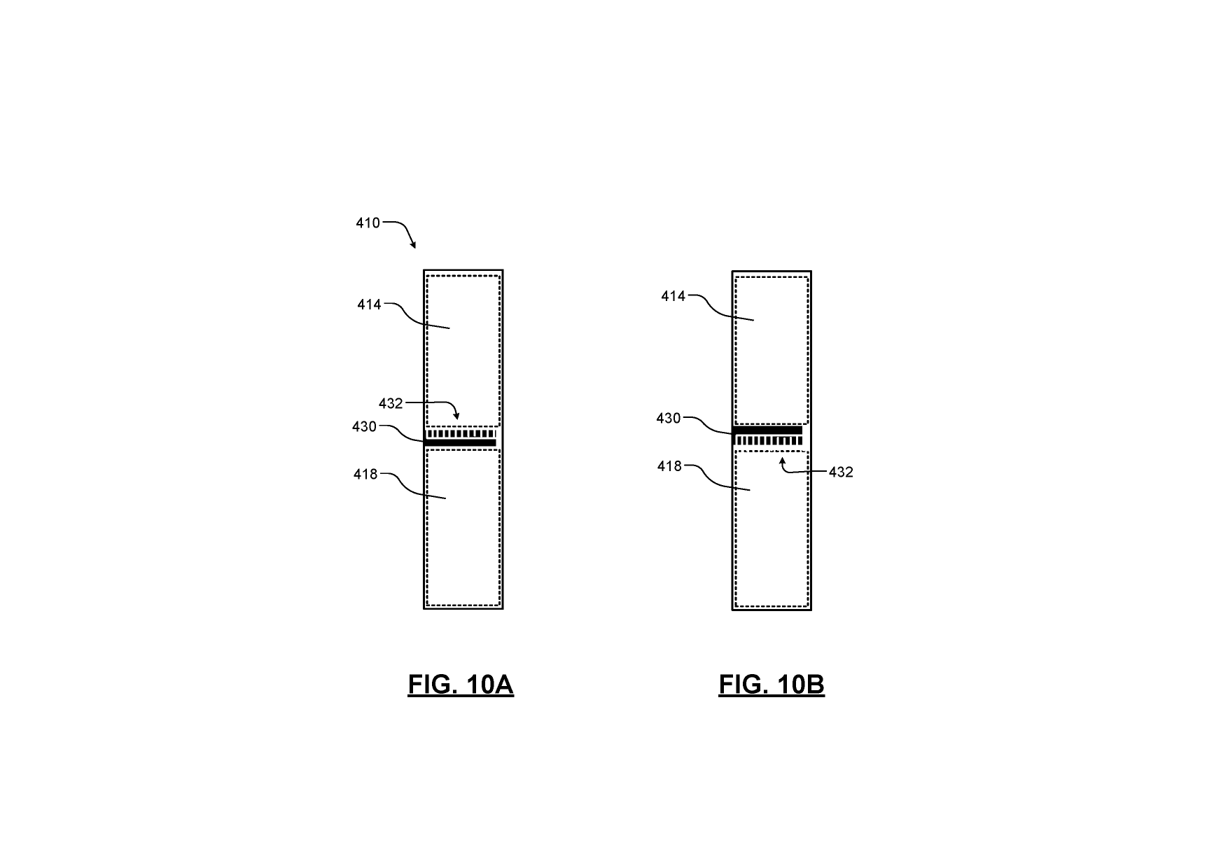

Referring now to FIG. 9, a battery cell 310 includes the first and second battery stacks or rolls 134 and 138 arranged in a battery enclosure with a gas guiding plate 320 arranged therebetween. In this example, gas guiding channels 324 pass through the gas guiding plate from one side to another. In other words, the gas guiding channels 324 are open to sides of the first and second battery stacks or rolls 134 and 138.

Referring now to FIGS. 10A and 10B, a battery cell 410 includes the first and second battery stacks or rolls 414 and 418 arranged in a battery enclosure in a direction transverse to the preceding examples and to the longitudinal direction of the wide faces. A gas guiding plate 430 with gas channels 432 is arranged between the first and second battery stacks or rolls 414 and 418. In other examples, a gas guide frame described below is used.

In some examples, a thickness of the gas guiding plate 430 is in a range from 1mm to 3 mm. In some examples, a thickness of the gas guiding plate 430 is in a range from 1.5mm to 2.5 mm (e.g., 2.0 mm). In some examples, the gas channels 432 have a depth in a range from 20% to 95% of the thickness of the gas guiding plate 430. In some examples, the gas channels 432 have a depth in a range from 65% to 85% of the thickness of the gas guiding plate 430.

Referring now to FIG. 11, a gas guide frame 510 is shown. The gas guide frame 510 is arranged between battery stacks or rolls as described above. The gas guide frame 510 includes at least one of a top frame member 540 and a bottom frame member 542 and/or first and second side frame members 544 and 546.

If the top frame member 540 and the bottom frame member 542 and the first and second side frame members 544 and 546 are used, the ends of the top frame member 540 are connected to upper ends of the side frame members 544 and 546. Ends of the bottom frame member 542 are connected to lower ends of the side frame members 544 and 546.

In some examples, the gas guide frame 510 has a rectangular shape. The gas guide frame 510 includes one or more holes 524 through at least one of top frame member 540, the bottom frame member 542, and the side frame members 544. In some examples, the one or more holes 524 are arranged on the frame member located adjacent to the vent on the lid. Gases produced by one of the battery stacks or rolls flow into a cavity 525 defined between the top frame member 540, the bottom frame member 542, and the side frame members 544 and 546. The gases flow through the one or more holes 524 adjacent to the vent.

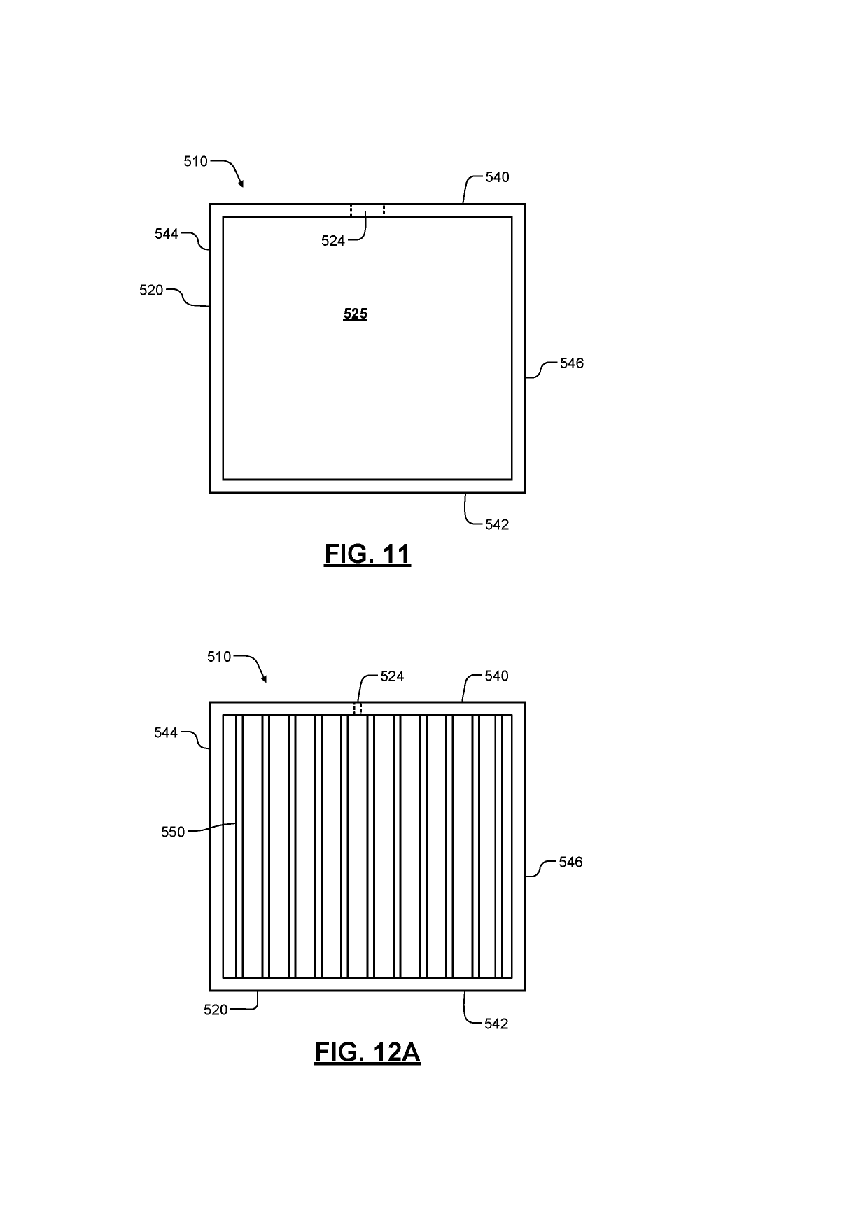

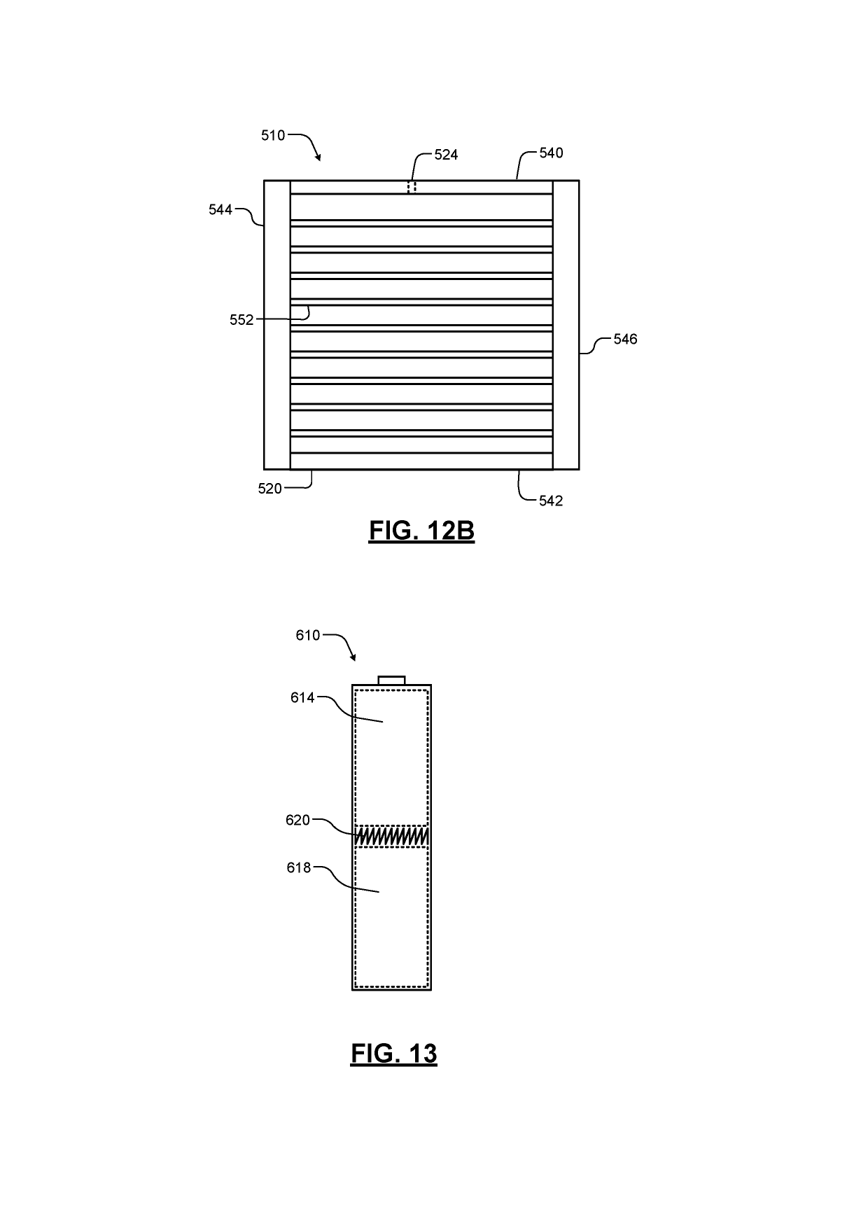

Referring now to FIGS. 12A and 12B, the gas guide frame 510 can be configured with vertical supports 550 and/or horizontal supports 552 extending between the top frame member 540 and the bottom frame member 542 (FIG. 12A) and/or between the side frame members 544 and 546 (FIG. 12B)). In some examples, a width or diameter of the vertical supports 550 and/or horizontal supports 552 is less than a width of the top frame member 540, the bottom frame member 542, and the side frame members 544 and 546 to allow gas to flow around the vertical supports 550 and/or horizontal supports 552 to the one or more holes 524.

Referring now to FIG. 13, a battery cell 610 including first and second battery stacks or rolls 614 and 618 arranged in a battery enclosure in a direction transverse to a longitudinal direction of a wide face. One or more springs 620 are arranged therebetween. In some examples, multiple springs 620 are arranged between the first and second battery stacks or rolls 614 and 618. Gas produced by one of the first and second battery stacks or rolls 614 or 618 passes through the springs 620 between the battery stacks or rolls and flows to the hole adjacent to the vent with less heating of the other one of the first and second battery stacks or rolls 614 and 618. In some examples, the spring is made of a material selected from a group consisting of polymer, composite, metal, and combinations thereof.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell, comprising:
a battery enclosure including a lid with a vent;
N battery portions arranged in the battery enclosure and including a plurality of cathode electrodes, anode electrodes and separators, wherein the N battery portions comprise one of a battery stack and a battery roll and wherein N is an integer greater than one; and
G gas guiding plates arranged between at least two of the N battery portions and including a plurality of gas channels configured to guide gases produced by the at least two of the N battery portions towards the vent, where G is an integer greater than zero.

2. The battery cell of claim 1, wherein:
the battery enclosure is a prismatic enclosure including wide faces and narrow faces, and
the N battery portions extend in a longitudinal direction of the wide faces.

3. The battery cell of claim 1, wherein:
the battery enclosure is a prismatic enclosure including wide faces and narrow faces, and
the N battery portions extend in a direction transverse to a longitudinal direction of the wide faces.

4. The battery cell of claim 1, wherein:
the plurality of gas channels extend from one side of the N-1 gas guiding plates to the other side,
lower ends of the plurality of gas channels are one of open and closed, and
upper ends of the plurality of gas channels are open.

5. The battery cell of claim 1, wherein:
the plurality of gas channels of the N-1 gas guiding plates include first gas channels on one side of the N-1 gas guiding plates and second gas channels on an opposite side of the N-1 gas guiding plates,
lower ends of the first gas channels and the second gas channels are one of open and closed, and
upper ends of the first gas channels and the second gas channels are open.

6. The battery cell of claim 5, wherein:
the first gas channels and the second gas channels extend vertically, and
the first gas channels are laterally offset from the second gas channels.

7. The battery cell of claim 6, further comprising:
first and second covers extending over the first gas channels and the second gas channels, respectively,
wherein the first and second covers include a plurality of gas holes in fluid communication with the first gas channels and the second gas channels, respectively.

8. The battery cell of claim 7, wherein the first and second covers are separate from the N-1 gas guiding plates.

9. The battery cell of claim 7, wherein the first and second covers are formed integrally with the N-1 gas guiding plates.

10. The battery cell of claim 1, wherein the N-1 gas guiding plates are made of a material selected from a group consisting of polymer, composite, metal, and combinations thereof.

11. A battery cell, comprising:
a battery enclosure including a lid with a vent;
N battery portions arranged in the battery enclosure and including a plurality of cathode electrodes, anode electrodes and separators, wherein the N battery portions comprise one of a battery stack and a battery roll and N is an integer greater than one; and
G gas guiding frames arranged between at least two of the N battery portions and including at least one of:
a top frame member and a bottom frame member; and
first and second side frame members
wherein G is an integer greater than zero and the G gas guiding frames define a cavity with sides of corresponding ones of the N battery portions,
wherein at least one of the at least one of the top frame member and the bottom frame member and the first and second side frame members includes one or more holes adjacent to the vent.

12. The battery cell of claim 11, wherein the battery enclosure is a prismatic enclosure including wide faces and narrow faces, and wherein the N battery portions extend in a longitudinal direction of the wide faces.

13. The battery cell of claim 11, wherein:
the battery enclosure is a prismatic enclosure including wide faces and narrow faces, and
the N battery portions extend in a direction transverse to a longitudinal direction of the wide faces.

14. The battery cell of claim 11, further comprising a plurality of supports extending between the top frame member and the bottom frame member.

15. The battery cell of claim 11, further comprising a plurality of supports extending between the side frame members.

16. The battery cell of claim 11, wherein the N-1 gas guiding frames are made of a material selected from a group consisting of polymer, composite, metal, and combinations thereof.

17. A battery cell, comprising:
a battery enclosure including a lid with a vent;
N battery portions arranged in the battery enclosure and including a plurality of cathode electrodes, anode electrodes and separators, wherein the N battery portions comprise one of a battery stack and a battery roll and N is an integer greater than one; and
one or more springs arranged between the N battery portions.

18. The battery cell of claim 17, wherein:
the battery enclosure is a prismatic enclosure including wide faces and narrow faces, and
the N battery portions extend in a direction transverse to a longitudinal direction of the wide faces.

19. The battery cell of claim 17, wherein the one or more springs are made of a material selected from a group consisting of polymer, a composite, metal, and combinations thereof.
